(19) United States
(12) Patent Application Publication
(10) Pub. No.: US 2004/0050653 A1
(43) Pub. Date: Mar. 18, 2004

(54) Compact turkey gathering machine

(76) Inventor: Enrico Mola, Castelmella (IT)

Correspondence Address: MODIANO & ASSOCIATI, Via Meravigli, 16, MILANO, 20123, IT

(21) Appl. No.: 10/637,673

(22) Filed: Aug. 11, 2003

(30) Foreign Application Priority Data
Aug. 29, 2002 (IT) MI2002A001864

(51) Int. Cl. B65G 41/00

(52) U.S. Cl. 198/300

(57) ABSTRACT

A turkey gathering machine comprising a structure that supports turkey gathering elements and conveyors for conveying the turkeys toward a loading station; the structure can move so that it can be arranged closer to the turkeys as they are gathered, without requiring the poultry to walk for long distances.

### BACKGROUND OF THE INVENTION

The present invention relates to a compact turkey gathering machine for gathering turkeys and other poultry from the floor of the building of the farm and arranging them in cages for transport.

Turkeys are reared in buildings, from which they must then be removed to be transported elsewhere for the subsequent steps that precede their sale.

Buildings used for farming have a typically rectangular plan, with a width of approximately 12-16 meters and a length of approximately 50-150 meters. In these buildings it is known to use, on one of the sides, a fixed system constituted by a conveyor belt in order to convey the turkeys out of the building and arrange them in the cages for transport.

This operation, completed by means of this known apparatus, requires the turkeys to be in the vicinity of the upstream end of the conveyor belt, where workers traditionally induce them to climb onto the conveyor belt.

Another known system is to use a capture cage, which is operated by an operator and induces the turkeys by mechanical means to climb onto the belt. The inclination of the belt is adjustable, so that its end section can be placed proximate to all the accesses to the cages, which are located at different heights. Such cages are in fact divided into stacked compartments and are typically already arranged in a stack on the trucks which, once full, will transport them to their destination.

In order to provide faster placement of the turkeys in the cages, an apparatus is known which is designed to be associated with the end section of the conveyor belt and is constituted by two belts that are arranged in parallel and can move independently of each other. In this manner, two operators located proximate to the openings of the cages can easily arrange the turkeys inside them.

This system currently used to collect turkeys from the farm has drawbacks.

First of all, the system constituted by the conveyor belt and optionally by the capture cage can move half inside the building and half outside. This fact requires the operators to gather the turkeys over the entire length of the building in order to group them proximate to the side of the building where the belt is located. Since the turkeys are often unable to walk or walk with difficulty, this operation is long and awkward.

The use of the capture cage facilitates only partially the work of operators, since it does not avoid the need to move through the building more than once in order to retrieve distant turkeys.

### SUMMARY OF THE INVENTION

The aim of the present invention is to provide a turkey gathering machine that overcomes the drawbacks of the cited known art.

Within this aim, an object of the present invention is to provide a turkey gathering machine that is capable of operating also inside the building used for farming.

A further object of the invention is to provide a turkey gathering machine that can operate in more than one building used for farming.

Another object is to provide a turkey gathering machine that has a limited space occupation when it remains unused and during transport.

Still a further object of the invention is to provide a turkey gathering machine that allows to work with a reduced number of operators.

Another object of the invention is to provide a turkey gathering machine that is economically advantageous and is safe and comfortable to use.

This aim and these and other objects are achieved by a turkey gathering machine as claimed in the appended claims.

### BRIEF DESCRIPTION OF THE DRAWINGS

Further characteristics and advantages of the invention will become better apparent from the detailed description of a particular embodiment thereof, illustrated by way of non-limitative example in the accompanying drawings, wherein:

FIG. 1 is a perspective view of the machine according to the invention, shown in the gathering position;

FIG. 2 is a plan view of the machine according to the invention, shown in the gathering position;

FIG. 3 is a side elevation view of the machine, shown in a collapsed position;

FIG. 4 is a view that is similar to FIG. 3 but illustrates the machine in the gathering position;

FIG. 5 is a view that is similar to FIG. 4 but illustrates the machine in an intermediate open or closed position.

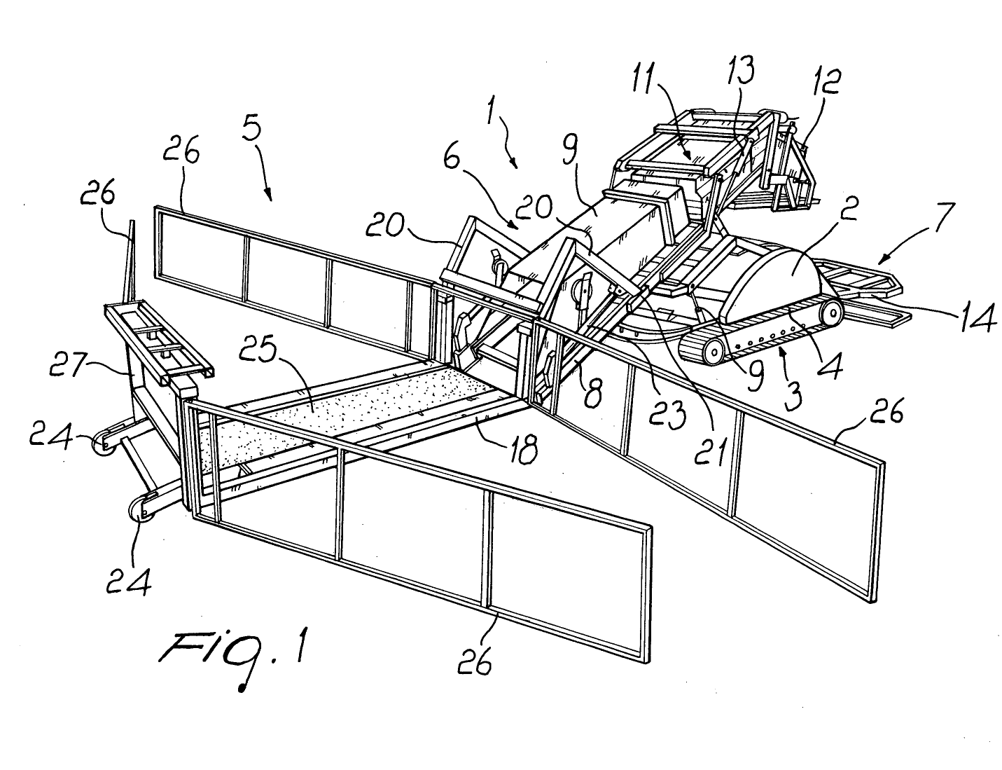

### DESCRIPTION OF THE PREFERRED EMBODIMENTS

With reference to the figures, the machine according to the invention, generally designated by the reference numeral 1, comprises a supporting structure 2, which supports turkey gathering means, generally designated by the reference numeral 5, and turkey conveyance means, generally designated by the reference numeral 6, which are adapted to convey the turkeys into a loading station, designated by the reference numeral 7.

According to the invention, the supporting structure is self-propelled, so as to be arranged in a turkey gathering area, near the turkeys, moving it toward them as they are gathered and loaded into the coops. The machine can then be removed once gathering is complete.

The supporting structure 2 comprises, for this purpose, self-propelled means 3, which are constituted by a motorized truck provided with wheels or, in the specific case, tracks 4.

The conveyance means 6 comprise an oscillating frame 8, which is articulated to the supporting structure 2 by means of a pair of arms 9, each of which is pivoted in the structure 2 by means of a pivot 10. The oscillating motion of the frame 8 is actuated by actuators which are constituted, in the specific case, by hydraulic actuators 11, so that the frame 8 can assume at least two positions: a lower one, which is used during the gathering and conveyance of the turkeys, and a raised one, shown in FIG. 3, which is used during the movement of the machine and during loading into the various levels of the cages.

The frame 8 comprises a conveyor belt, not shown in the figures, which is closed by a box-like body 19 that is adapted to transfer the turkeys that arrive from the gathering means to an insertion unit 10, which comprises, in the specific case, two parallelogram-like elements 11 that are adapted to convey the turkeys that arrive from the belt of the frame 8 into a respective insertion unit 12.

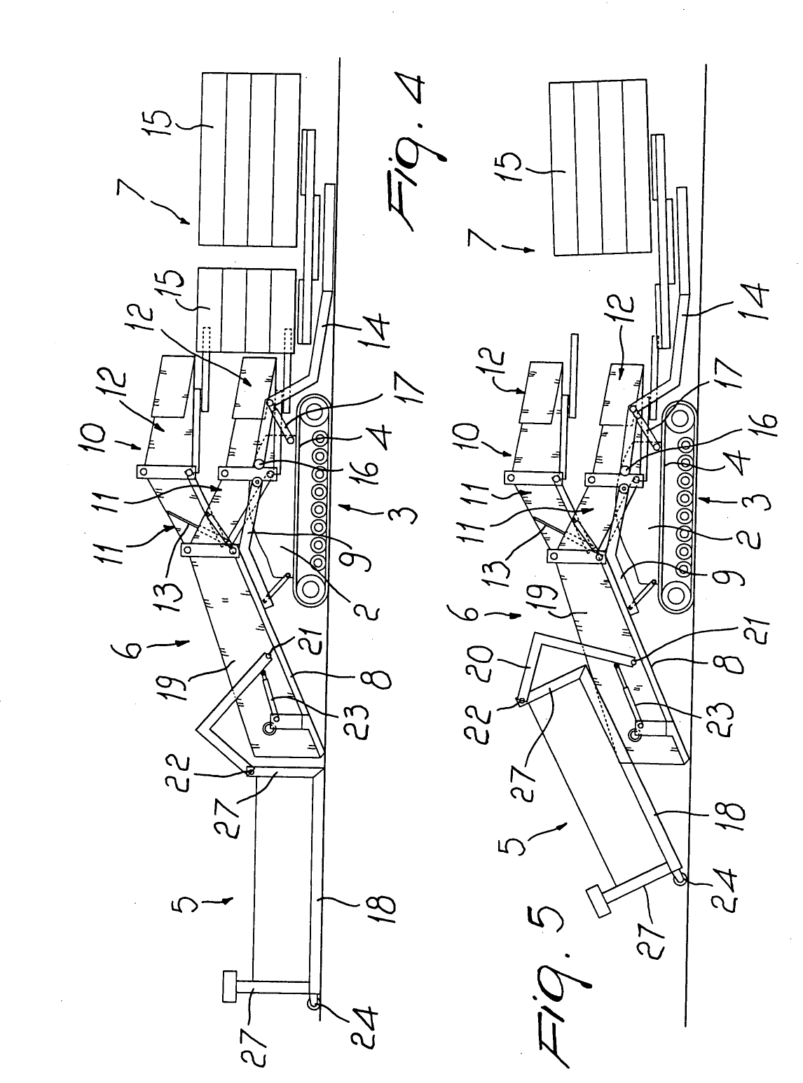

Each parallelogram-like element 11, which comprises a conveyor belt, is adapted to position the respective insertion unit 12, which also comprises a conveyor belt, at different heights in order to allow to insert a turkey in several cages 15 arranged at different heights in the loading station 7, as shown schematically in FIG. 4.

The movement of the parallelogram-like elements 11 is actuated by hydraulic actuators 13 and allows to keep the respective insertion units always parallel to the ground, thus facilitating the insertion of the turkeys in the cages, which are conveniently arranged in the loading station 7.

The loading station 7 is constituted by an oscillating loading frame 14, which is articulated to the supporting structure 2 by way of a pivot 16. The oscillating motion of the loading frame 14 is actuated by actuators, which are constituted, in the specific case, by hydraulic actuators 17, so that the frame 14 can assume at least two positions: a lowered one, which is used during the gathering and conveyance of the turkeys, and a raised one, shown in FIG. 3, which is used during the movement of the machine.

The loading frame 14 is provided with means for moving the cages 15, which are adapted to arrange the cages in a position for the insertion of the turkeys.

On the other side of the machine, to the left with reference to the figures, the gathering means 5 are constituted by a gathering frame 18, which is articulated to the oscillating frame 8 of the conveyance means by way of a pair of arms 20, each of which is pivoted to the oscillating frame 8 by way of a pivot 21 and to the gathering frame 18 by way of a pivot 22. The oscillating motion of the gathering frame 18 is actuated by actuators which are constituted, in the specific case, by hydraulic actuators 23, which are associated with the oscillating frame 8 and with the arms 20, so that the gathering frame 18 can assume at least two positions: a lowered position, which is used during the gathering and conveyance of the turkeys, and a raised position, which is visible in FIG. 3 and is used during the movement of the machine.

The gathering frame 18 has, at its free end, wheels 24 that allow to drag the free end on the ground when the gathering frame 18 is moved from the lowered position to the raised position and vice versa. FIG. 5 illustrates an intermediate step of this movement.

The gathering frame 18 is provided with a conveyor belt 25, on which the turkeys gathered in the adjacent area are grouped by means of a system of gates or barriers 26 that are pivoted to suitable posts 27 of the gathering frame 18 and can be folded onto the sides of said frame when the machine is moved to the transport position.

Operation of the machine according to the invention is as follows.

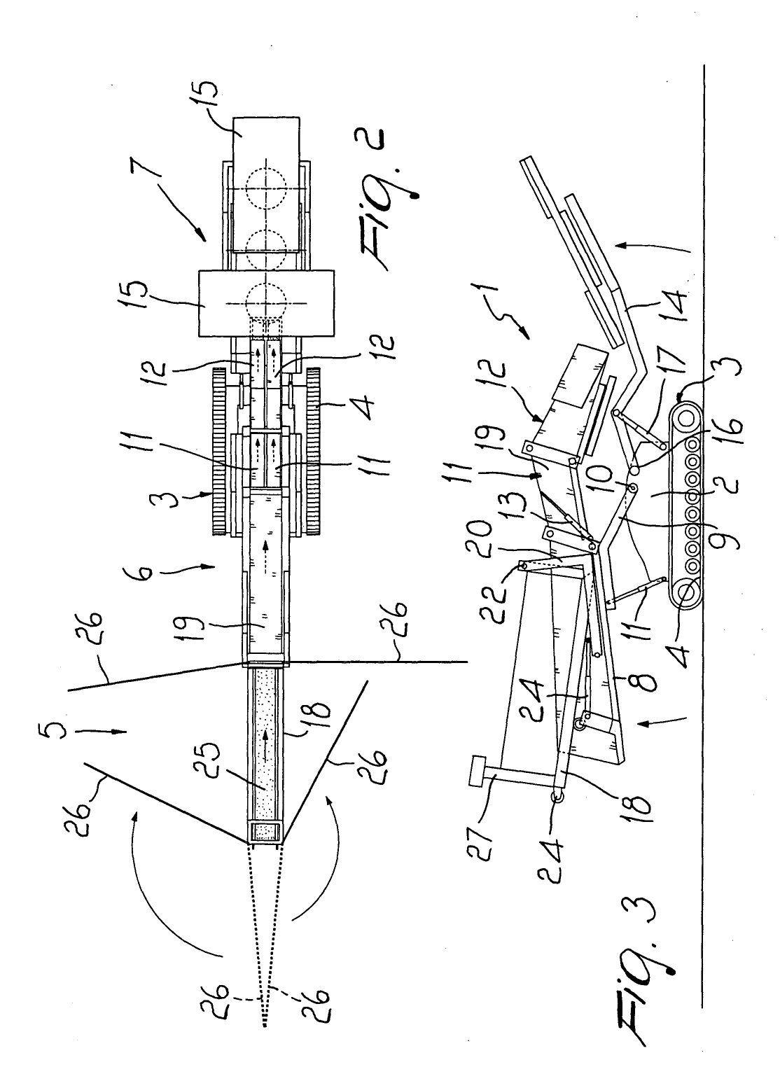

The machine, in the collapsed position shown in FIG. 3, is arranged in a preselected gathering place and by actuating the actuators is moved into the gathering position, in which the gathering frame 18 is flat on the ground with the barriers walls 26 open, and the loading station 7 has cages 15 that are ready for the introduction of the turkeys, as shown in FIGS. 2 and 4.

The conveyor belts are actuated and, with the aid of the barriers 26, the turkeys are induced to climb onto the conveyor belt 25 of the gathering frame.

The turkeys are then transferred into the cages 15 by way of the insertion units 12.

Once a group of turkeys has been gathered, the machine is moved toward the next group of turkeys, and so forth, up to the end of the building.

Once the gathering operation has ended, the machine is placed in the collapsed position and is moved to another place of use or simply stored.

In practice it has been found that the invention has achieved the intended aim and objects, a self-propelled machine having been provided which can be moved toward the poultry to be picked up.

The machine according to the invention is susceptible of numerous modifications and variations, all of which are within the scope of the appended claims; all the details may further be replaced with other technically equivalent elements.

Finally, the materials used, as well as the dimensions, may be any according to requirements.

The disclosures in Italian Patent Application No. MI2002A001864 from which this application claims priority are incorporated herein by reference.

What is claimed is:

1. A turkey gathering machine, comprising a structure that supports turkey gathering means and conveyance means for conveying the turkeys toward a loading station, wherein said structure can move within a farm so as to be moved closer to the turkeys as they are gathered and so as to be removed from the farm once gathering has been completed.

2. The turkey gathering machine according to claim 1, wherein said gathering means and said conveyance means are constituted by conveyor belt sections that can move with respect to each other and with respect to said structure, so as to determine at least a gathering position and a collapsed position, in which the dimensions of the machine are reduced in order to facilitate its transfer.

3. The turkey gathering machine according to claim 2, wherein said sections are mutually articulated.

4. The turkey gathering machine according to claim 1, wherein said conveyance means comprise a main line that is adapted to accommodate the turkeys that arrive from said gathering means and to convey them into one or more positioning units that are associated with said main line by way of a parallelogram structure; said positioning units being adapted to convey the turkeys into said loading station.

5. The turkey gathering machine according to claim 1, wherein said conveyance means comprise an oscillating frame that is articulated to the supporting structure by way of a pair of arms, each of which is pivoted in the structure by way of a pivot; the oscillating movement of the frame being actuated by actuators so that said frame can assume at least two positions: a lowered one, which is used during the gathering and conveyance of the turkeys, and a raised position, which is used during the movement of the machine.

6. The turkey gathering machine according to claim 5, wherein said oscillating frame comprises a conveyor belt that is adapted to transfer the turkeys that arrive from said gathering means to an insertion unit.

7. The turkey gathering machine according to claim 6, wherein said insertion unit comprises a pair of parallelogram elements, which are adapted to convey the turkeys that arrive from the belt of said oscillating frame into a respective insertion unit.

8. The turkey gathering machine according to claim 7, wherein each parallelogram element comprises a conveyor belt and is adapted to arrange the respective insertion unit, which also comprises a conveyor belt, at different heights in order to allow the introduction of a turkey in various cages arranged at different heights in the loading station.

9. The turkey gathering machine according to claim 8, wherein the movement of said parallelogram elements is actuated by hydraulic actuators and allows to keep the respective insertion units always parallel to the ground, so as to facilitate the insertion of the turkeys in the cages arranged in said loading station.

10. The turkey gathering machine according to claim 5, wherein said loading station comprises an oscillating loading frame, which is articulated to the supporting structure by way of a pivot; the oscillating motion of the loading frame being actuated by actuators so that said loading frame can assume at least two positions: a lowered position, which is used during the gathering and conveyance of the turkeys, and a raised position, which is used during the transfer of the machine.

11. The turkey gathering machine according to claim 8, wherein said loading frame is provided with means for moving the cages which are adapted to arrange said cages in a turkey insertion position.

12. The turkey gathering machine according to claim 5, wherein said gathering means comprise a gathering frame, which is articulated to said oscillating frame by way of a pair of arms, each of which is pivoted to the oscillating frame by way of a pivot and to the gathering frame by way of a second pivot; the oscillating motion of the gathering frame being actuated by actuators that are associated with the oscillating frame and with the arms, so that the gathering frame can assume at least two positions: a lowered position, which is used during the gathering and conveyance of the turkeys, and a raised position, which is used during the transfer of the machine.

13. The turkey gathering machine according to claim 12, wherein said gathering frame has, at its free end, wheels that allow to drag the free end over the ground when the gathering frame is moved from the lowered position to the raised position and vice versa.

14. The turkey gathering machine according to claim 12, wherein said gathering frame has a conveyor belt on which the turkeys gathered in the adjacent area are grouped by means of a system of barriers that are pivoted to posts of the gathering frame and can be folded onto the sides of said frame when the machine is moved into the transport position.

15. The turkey gathering machine according to claim 1, wherein said gathering means are interchangeable with other devices.

16. The turkey gathering machine according to claim 15, wherein said turkey gathering means can be replaced with a chicken gathering head and the like.

17. The turkey gathering machine according to claim 15, wherein said gathering means can be replaced with different equipment, such as shovels for gathering manure, lift-truck forks, sweeping units for yards, etc.
